(19) United States
(12) Patent Application Publication
(10) Pub. No.: US 2019/0034468 A1
(43) Pub. Date: Jan. 31, 2019

(54) Foundation Theory And Method of Internet Map/Platform Iconology/Markerology

(71) Applicants: Qiang Wang, San Jose, CA (US); Xinwei Wang, San Jose, CA (US); Yong Wang, Suzhou (CN); Jin Wang, Lang Fang (CN); Zhaoyang Wang, San Jose, CA (US)

(72) Inventors: Qiang Wang, San Jose, CA (US); Xinwei Wang, San Jose, CA (US); Yong Wang, Suzhou (CN); Jin Wang, Lang Fang (CN); Zhaoyang Wang, San Jose, CA (US)

(73) Assignees: Qiang Wang, San Jose, CA (US); Xinwei Wang, San Jose, CA (US); Jin Wang, San Jose, CA (US); Yong Wang, San Jose, CA (US)

(21) Appl. No.: 16/040,917

(22) Filed: Jul. 20, 2018

Related U.S. Application Data
(63) Continuation of application No. 15/664,152, filed on Jul. 31, 2017.
Application No. 15/664,152 is a continuation of application No. 15/821,813, filed on Nov. 23, 2017.

(51) Int. Cl. G06F 17/30; G06F 17/24; G06Q 10/10

(52) U.S. Cl. CPC G06F 17/30339; G06Q 10/10; G06F 17/245

(57) ABSTRACT

The present invention discloses the foundation theory and method of the internet map/platform Iconology/Markerology which is characterized in followings: the invention firstly establishes the foundation theory of internet map/platform iconology, its specification, standards and methods including a complete theoretical dynamic icon/marker management system, basic concepts, categories, judgments and inferences, definitions, rules and methods, According to the foundation theory and method of Internet Map/Platform Iconology/Markerology, the user can use the iconology theory and methods specified in the present invention to identify almost everything on the internet maps or platforms and to perform various operations and to control all of the icons/markers on the internet maps/platforms and also to connect to variety of external network resource and network platforms to get in touch with various network businesses through these internet map icons/markers enriched with infinite network resource spaces. Actually, Icon/marker economic activity that is currently limited with traditional Internet map technology so far will become main tendency in future with the present invention. In particular, the present invention assigns a unique icon/marker Identification (IID) number to each valid icon/marker on the internet map and in future we can use this IID to identify almost everything on any kinds of network platforms and can control all the targets/objects of both the Internet of Things (IoT) and the Internet just by controlling all the icons/markers on the internet map/platform through unique icon/marker Identification number (IID). The Cardinality of icon/marker Identification (IID) is Second Level Infinity.

### FIELD OF INVENTION

The present invention relates to the field of internet map/platform icons/markers. More particularly the invention relates to the foundation theory and method of Internet Map/Platform Iconology/Markerology.

### BACKGROUND

The internet maps represented by Google Map, MapQuest, Baidu Map etc have an very huge market with the largest number of users in the world. However, so far, all internet map vendors and providers, scientists and engineers have not yet carried out any foundational theoretical research and study on internet maps and related technological fields. Without the creation of foundation theory, there is no progress of the technological revolution; without technological revolution, there is no subversion of product substitution; the foundation theory and method of internet map iconology created by the present invention is a breakthrough in the fundamental theory and the invention of the theoretic and technological revolution.

The icons/markers are the most important basic elements of all network platforms such as internet maps, GIS platforms and IoT platforms. The basic theory and method of internet iconology is the discipline that reveals the basic laws of the most important basic elements of all Internet platforms. The invention originates from a network map platform and then extends to the entire scope of the internet network platforms.

The series of inventions we previously applied for in the field of internet map icons/markers in USPTO have thoroughly analyzed the congenital deficiency and fatal genetic defects of traditional internet maps, and the present invention is the first one in the world to declare clearly that Iconology is a totally new field of internet maps in computer science. The present invention completely creates a new field: the field of icons/markers of internet maps/platforms; the present invention also creates a new discipline: iconology/markerology in computer science. The major core part of the whole theory of this iconology consists of the following patents that we have submitted in USPTO, please see Reference [1] and [2]:

The above-mentioned original series of inventions and the establishment of iconology disciplines provide a basic theoretical basis for the next generation of brand new internet maps and platforms. Below we will further refine this foundation theory, standards and technical innovations by adding more new concepts and methodology to complete the iconology system.

### BRIEF SUMMARY OF INVENTION

The present invention discloses a completely innovative foundation theory and method of Iconology/Markerology, which is characterized and composed of a series of parts of all core concepts, standards, categories, operations, rules and all different kinds of relationships, it includes:

Part 1: The foundation principle of the icons/markers (40 items);
Part 2: The type of icons (12 items);
Part 3: The relationship between icons (10 items);
Part 4: the operation of icons (8 items);
Part 5: The functions of the icon (8 items);
Part 6: The scope of application of the icons (15 items);
Part 7: The number of valid/effective icons (3 items);
Part 8: Economic Value of valid/Effective Icons in Social and Economic Production Activities (2 items);
Part 9: The scale of the icon economy (l items);
Part 10: Effective icons and QR codes (1 item);
Part 11: The foundation theory and method of Internet Map Iconology/Markerology and the three super platforms of present invention;
Part 12: Icon Identification Number (IID) and traditional network platform User Identification (UID).

### Part 13: Icon Events.

### Part 14: Icon Prediction.

### Part 15: The Positioning Point.

### Part 16: The Controllable Positioning and the Positioning Controllable.

### Part 17: The Icon Information Bus (IIB).

### Part 18: The Controllable Positioning Identification Number (CPID) vs Icon Identification (IID)

All will be defined and explained as follows.

### BRIEF DESCRIPTION OF DRAWINGS

Some of the embodiments of the present invention are illustrated as examples and are not limited by the figures of accompanying drawings, in which like references may indicate similar elements and in which:

FIG. 1 shows the various relationships between the persons and things. It is an important part of iconology foundation theory.

FIG. 2 shows the concept of Icon/Marker Resource Folder and its application on a internet map of ordinary PC or mobile device;

FIG. 3 shows the concept of Icon/Marker Resource Folder and its application on the internet map of ordinary PC or mobile device;

FIG. 4 shows the relationship among the Icon/Marker Interface Tabs, Icon/Marker Resource Folders and icons/markers that can be nested within each other to form a very complex structure;

FIG. 5 shows how the simple web page/dialog box containing the icon's resource space is displayed after the internet map icons and overlapping icons/markers are clicked. Here the right side is the internet map of an ordinary PC or mobile device. Click the overlapping icon#5 that contains 7 icons/markers of SCDAGM, then 7 icons/markers of SCDAGM will be displayed in a dialog box/web page popped up on the left, and then click on the 6th icon circled in the dialog box with arrow toward right, it will open another dialog box again to get its full resource space displayed. The 6th icon resource space includes the resource folder, entity table, other icons, interface tabs and so on. The resource space of each icon/marker of the overlapping group icons/markers can be extended indefinitely.

FIG. 6 shows how the simple web page/dialog box contained the icon's resource space is displayed after the internet map icon/marker is clicked. However, the difference is that the interface tabs is loaded in the simple web page/dialog box and multiple different resource containers such as resource folders, entity tables, sub-interface tabs, icons/markers again, and other elements of buttons etc are also loaded in the root level interface tabs. As the arrow indicated, once icon#5 was clicked, on the left side, a dialog box will pop up and it contains a interface tabs, the user can use the buttons at the bottom of it to manipulate and control all elements with in the interface tabs or some drag and drop functionality.

FIG. 7 shows the next generation of super finite platform that is composed of traditional normal internet platforms such as Alibaba, Amazon, Yahoo, Google etc plus the present invention of the Icon/Marker Dynamic Management System of Iconology/Markerology.

FIG. 8 shows the next generation of super social platform that is composed of traditional normal internet social platforms such as Wechat, Whatsapp, Snapchat, Facebook etc plus the present invention of the Icon/Marker Dynamic Management System of Iconology/Markerology.

FIG. 9 shows the next generation of super infinite platform that is composed of traditional normal internet platform such as Google Map, Apple Map, MapQuest, Here Map, BaiduMap, SogouMap, QQMap, GaodeMap etc plus the present invention of the Icon/Marker Dynamic Management System of Iconology/Markerology.

FIG. 10 shows that both icon events and group icon events are all composed of Icon and Time. It also shows that Icon Event is same as Icon Activity defined here.

FIG. 11 is the concept of the Icon Information Bus (IIB), which is the information bus used by all network platforms to exchange and transmit the icon identification number with each others and to exchange information with the icon management server. It is the main information bus to integrate the icon resources of all network platforms with all icons and all platforms.

FIG. 12 is the concept of the Controllable Positioning Information Bus (CPIB), which is the information bus used by all network platforms to exchange and transmit the Controllable Positioning Identification number (CPID) with each others and to exchange information with the Controllable Positioning Management Server. It is the main information bus to integrate the all Controllable Positioning resources of all network platforms with all controllable positioning points and all platforms.

### DETAILED DESCRIPTION OF THE INVENTION

The Terminology used herein is for the purpose of describing particular embodiment only and is not intended to be limited to be limiting of the invention. as used herein, the term “and/or” includes any and all combinations of one or more of the associated listed items. As used herein, the singular forms “a”, “an”, and “the” are intended to include the plural forms as well as the singular forms, unless the context clearly indicates otherwise, It will be further understood that the terms “composed” and/or “comprising,” when used in this specification, specify the presence of stated features, steps, operations, elements and/or components, but do not preclude the presence or addition of one or more other features, steps, operations, elements, components, and/or groups thereof.

Unless otherwise defined, all terms (including technical and scientific terms) used herein have the same meanings as commonly understood by one having ordinary skill in the art to which this invention belongs. It will be further understood that terms, such as those defined in commonly used in dictionaries, should be interpreted as having a meaning that is consistent with their meaning in the context of the relevant art and the present disclosure and will not be interpreted in an idealized or overly formal sense unless expressly so defined herein.

Here we define that all icons are same as the markers in internet maps in our present invention, ie icon is same as marker and that Iconology is same as Markerology, and that internet is same as networks in the present invention, also we define valid icon/markers are same as effective icon/markers. Here valid/effective icon/markers means that these icon/markers are associated with human beings daily life or business commercial or production or social activities such as shopping, hospital, education, tour, transportation, agriculture, manufacturing etc, we also define that the internet map also is an abbreviation of internet map/platform, because the icons/markers we use here can be not only used in the internet maps such as Google Map, Baidu map etc but also used in all other platforms and their applications such as all types of GIS and all types of IoTs, so the term of platform or “Platform” means all different types of GIS platforms or all different types of LoT platforms or any platforms that will use the concepts of icons/markers or the similar defined here. We define that the term of “mirror” is same as mirroring in our present invention.

The present invention is the foundation theory and method of iconology in the internet map/platform. The present invention can be applied to all kinds of internet maps such as Google Map, Apple Map, MapQuest, BaiduMap, Gaode Map etc and can be also applied to all internet platforms such as all kinds of GIS platforms and all kinds of IoT Platforms and the similar ones. This is currently impossible with traditional internet map technology.

the foundation theory and method of iconology are divided into the following 14 parts so far:

### Part 1: The Foundation Principle of the Icons/Markers;

(1). Internet map has two foundation elements: background map and the pixels (or the map pixels) on the background map;
(2). The background map consists of infinite number of pixels on the background map with accurate values of longitude, latitude, and altitude measured, so the pixel points on the internet map are the key to form and construct the internet maps; It plays extremely important role in internet map in the present invention, which was ignored by all internet map providers so far.
(3). The number of pixels (pixel elements) on the background map of the internet map are endless, and each pixel can be represented by an icon/marker;
(4). Icons/markers that have the same latitude and same longitude but have the same or different height can be distinguishable;
(5). The icon/marker as a whole on the internet maps is a new and huge field;
(6). All icons/markers on the internet map can be controlled and managed;
(7). All icons/markers on the internet map are extendable;
(8). All icons/markers on the internet map can be changed/updated;
(9). All icons/markers on the internet map can be dynamic and/or static;
(10). All icons/markers on the internet map are 3-dimensional or multidimensional;
(11). All icons/markers on the internet map have their own networks resource spaces;
(12). All valid/effective and valuable icons/markers of internet maps are all closely related to peoples' daily life, business, social and production activities, etc.
(13). The icons'/markers' networks resource space consists of any number of icons/markers, icon resource containers, ie icon/marker interface tabs and icon/marker resource folders etc;
(14). The icon/marker resource containers, including the icon/marker interface tabs and the icon/marker resource folders are the containers to load, hold and accommodate all kinds of internet resources;
(15). The foundation theory and method of Internet Map Iconology/Markerology is the foundation theory of the Internet map;
(16). All Internet platforms have primitive elements (background components) of the original Internet platform, such as the pixel, image, icons, all kinds of buttons, drop-down menus, check boxes, drop-down boxes, dialog boxes, etc., all we define them as Original Platform Background Component Elements (OPBCE). These original internet platform Original Platform Background Component Elements (OPBCE) have basic properties/attributes and values, which are referred to as the Original internet platform Background Information (OBI) of original Internet platforms. However, For different types of platforms, there are different types of original platform background component elements (OPBCE), so the original background information (OBI) is also different. What is more important is that the Original Background Information (OBI) Contents of different types of platforms are also different. We define the Original Background Information Contents as follows: how much the Original Background Information (OBI) an internet platform contains. Here OBI content is an indicator to indicate how much information a platforms can hold/contain, it is very useful to help decide which platforms can perform more difficult or easy tasks or what kinds of internet activities/operations they can perform in the future and the reasons.
(17). The Original Background Information (OBI) of the internet platform is the original information that the platform does not load any internet resources such as customers, contacts etc in its initial state or start-up. For example, the initial state of Wechat or Snapchat has no items or a very few items after installation without loading/adding any contacts, and its Original Background Information (OBI) content is almost 0 or Zero (because their background is a whiteboard); ordinary or normal websites such as the Meituan and yahoo.com, Kayak, Alibaba etc and their Original Background Information (OBI) are basically finite and static (because their Original background information (OBI) in those platforms are consisting of finite menu elements, input boxes, buttons, drop-down boxes, check boxes etc., theses are all the Original Platform Background Component Elements (OPBCE)); But the internet maps' original background Information is infinite and dynamic (because the Original Background Information (OBI) of Internet Map is infinite and dynamic and its background information is composed of pixels with dynamic values of exact latitude, longitude and altitude);

Using the Concept of Original Background Information (OBI) content, we can define clearly definitions of the three types of internet platforms for the foundation theory of the Iconology as follows:

(18). Category 1: Whiteboard Platforms, such as WeChat, QQ, Snapchat, Whatsapp, etc. are whiteboard background, ie, their Original Background Information (OBI) contents are 0 because there are almost no Original Platform Background Component Elements (OPBCE) on the platform, so the Original Background Information (OBI) content is zero or almost zero;
(19). Category 2: Finite Platforms, are very common internet platforms, such as Feifan, Meituan, Amazon, Kayak, Alibaba, etc. These kinds of platform are most popular websites and widely used internet platforms by almost all companies, governments and users. The background elements of this type of platform have items/elements such as: menu, button, tab page, drop-down menu, check boxes, input boxes. Output boxes, tables, folders, etc., but the number or quantity of these items/elements is finite or limited, not zero, so their Original Background Information (OBI) content is finite/limited;
(20). Category 3: Infinite Platforms: Infinite platforms are all internet map platforms, such as Google Maps, Baidu Maps, MAPQUEST, QQ maps, Europe HERE Map, Apple Map etc. The Original Platform Background Component Elements (OPBCE) of these platforms are the pixels on the internet map with pre-designed precise values of latitude, longitude and altitude, and the number of background elements of the platform is number of pixels on the internet map and is infinite. So the original background information (OBI) of the internet map platform is infinite, so its original background information content is infinite;

With definitions of these three type categories of clarification of internet platforms, we can clearly distinguish and classify all kinds of internet platforms currently used and we can know what features they have and where they can be applied to.

(21). Although the original background information (OBI) of the traditional internet maps is infinite & dynamic, the Original Platform Background Component Elements (OPBCE)(abbreviated as original background elements) contained in the traditional internet map are the map pixels, and traditional icons/markers are the representation or symbols of these pixels only. The attributes and properties of traditional icons/markers on the traditional internet maps are two-dimensional and finite so far. That is to say, each traditional icon/marker of traditional internet maps does not have the concept of infinite background resource space to hold/contain/connect infinite external internet resources. Therefore, the traditional internet map is still considered as the dynamic internet platform with infinite original background information (OBI) but finite background resource space. We define this kind of the dynamic internet platform with infinite original background information (OBI) but finite background resource space as Simple Single Layer Infinite Platform (SSLIP). Simple Single Layer Infinite Platform means it has Only one layer Infinity, ie the all Infinite pixels on the internet maps.
(22). The new internet maps/platforms built based on this iconology theory in the present invention have not only the features of all that their original background information (OBI) is infinite and dynamic and the features of that the original platform background component elements (OPBCE)(abbreviated as the original background element, such as pixels, button, drop down boxes, check boxes, dialog box etc) contained in the new internet maps/platforms, but also that their pixels have valid/effective icon/markers & can be extended to 3-Dimensional or even multi-dimension spaces instead of traditional 2 dimensions, that is to say, each icon/marker has an infinite background resource space bond to it for life time, so that the next-generation internet maps/platforms are ones with infinite original background information (OBI) and all OBI elements have infinite background resource space associated with them for each valid/effective elements or icons/markers on the platform for lifetime. This is totally different concept from what we defined before in (21) for Simply Single Layer Infinite Platform (SSLIP), It is a more complex and complicated structure of the dynamic internet platform we never have before, We define this kind of the dynamic internet platform with infinite original background information but infinite background resource space as Complicated Dual Layer Infinite Platform (CDLIP)(or simply referred to as a Dual-layer infinite platform). The reason and purpose that we construct so complicated internet platform CDLIP is that we will use it in the present invention. CDLIP is a huge internet platform with infinite and endless internet resource we never use before.
(23). All traditional internet maps are dynamic infinite platforms with finite resource space (or simple single-layered infinite platforms (SSLIP)). The SSLIPs have only a certain degree of integration capabilities to integrate other internet resources and they have very finite/limited development potentiality in integration of variety of internet platforms because icons/markers of S SLIP are only 2-dimensional elements, as we know any two dimensional elements can only contain or hold finite internet resources and cannot contain infinite internet resources.
(24). Dynamic internet platforms with original infinite background information (OBI) and infinite background resource space we defined as Complicated Dual Layer Infinite Platform (CDLIP)(or double layer infinite platform as abbreviation) is the most valuable internet platform with the highest degree of integration to integrate almost all current internet resources.
(25). Respectively, we define the static (dynamic) original background information (OBI) content refers to the original static (dynamic) background information, usually we define Original Background Information (OBI) content with three different values, they are zero/O, finite, infinity; Here:
A. the value of zero or 0 of OBI content is corresponding to WhiteBoard platform because it contain 0 value of OBI, examples of WhiteBoard platform are Wechat, Snapchat. qq etc;
B. the value of finite of any integer of OBI content is corresponding to finite platform because it contains a certain value of OBI, examples of finite platforms are Amazon, Youtube, Yahoo etc;
C. the value of infinite of OBI content is corresponding to infinite platform because it contains an infinite/countless number of OBI, examples of infinite platforms are Google Map, MapQuest etc;

Then, static original background information (OBI), dynamic OBI, static original background information (OBI) content and the dynamic original background information (OBI) content all have become an important indicators to accurately evaluate and describe the ability of any types of internet platforms to independently extend their network spaces and to integrate all other external internet resources without quitting current sessions to loss current session data then switching to other external internet platforms to perform more complicated and difficult tasks;

(26). The dynamic original background information (OBI) content of the internet platforms is the most important indicator of the degree of development and integration of the internet platform and their potential capabilities of development and integration. The dynamic original background information (OBI) content of the internet map platform has the highest value, ie. infinite, and therefore, the degree of development and potential integration capability of this kind of platform is the biggest. Also it can participate in the development and integration of very very complicated and more advanced internet resources and activities.
(27). The establishment of concepts such as the original background information (OBI) of the internet platform explains why some types of internet platforms (network platforms with zero content of dynamic original background information such as whiteboard platforms) cannot directly participate in manufacturing without switching or using other external internet platforms such as internet maps etc;
(28). Any internet platform with no original background information (OBI) or any internet platform with finite original background information (OBI) can not directly participate in most complicated and advanced internet activities if they did not switch to or rely on other external internet complicated platforms (such as finite or infinite platforms we defined before) because both the zero value or WhiteBoard platforms' Original Background information (OBI) and the finite platforms' Original Background information (OBI) hinders and limits the further development of these platforms.
(29). In the present invention, it considers that the Internet as a whole is a complete internet primitive ecological environment (IPEE), so this whole internet primitive ecological environment (IPEE) includes both the upstream internet primitive ecological environment and the downstream internet primitive ecological environment. Each of these internet primitive ecological environments will produce its own unique ecological environment resources. For example, the upstream internet primitive ecological environment includes the Internet, and the downstream network ecological environment includes the Internet of Things (IOT).

As we know, there are three different types of internet platforms, such as the whiteboard platforms, the finite platforms and the infinite platforms we defined and discussed earlier, each of internet platform has its own platform's primitive ecological environment resources, and the primitive ecological environment resources are actually the original background information (OBI) we define before.

For example, the whiteboard platform has almost no internet primitive ecological environment (IPEE) resources, while the finite platforms' internet primitive ecological environment (IPEE) resources are the basic components or elements of a finite and pre-designed elements in these internet platforms such as buttons, drop-down menus, dialog boxes, etc.; and the infinite platform has almost infinite internet primitive ecological environment (IPEE) resources: pixels.

The number of the internet primitive ecological environment (IPEE) resources of an infinite platform is infinity. They are all infinite pixels in the internet map. Therefore, in the upstream internet primitive ecological environment (IPEE), the infinite platforms such as Google Map and MapQuest etc have the most abundant natural primitive ecological environment resources.

However, the whiteboard platform hardly had any of the internet primitive ecological environment resources.

The downstream internet primitive ecological environment (IPEE) is the Internet of Things (IoT).

According to the foundation theory of the iconology, the richness of the IPEE resources in the upstream internet ecological environment (IPEE) directly affects the development of the downstream internet such as IoT.

Therefore, the upstream infinite platforms with the most abundant internet primitive ecological environment (IPEE) resources have the greatest impact on the downstream internet primitive ecological environment, namely the Internet of things (IoT).

Therefore, when there is a fatal flaw in the abundant natural internet primitive ecological environment (IPEE) resources of the upstream infinite platforms, it will inevitably hinder, impede even damage or hurt the development of the downstream internet primitive ecological environment (IPEE) such as the Internet of things.

(30). Since all traditional internet maps/platforms are dynamic infinite platforms with finite resource space (the above-mentioned Simple Single-Layer Infinite Platform (SSLIP)), that is, the information of the resource space of the dynamic Original Platform Background Component Elements (OPBCE) of all current internet platforms is finite, and of course their information content is also finite;
(31). Because next-generation internet maps/platforms are dynamic infinite platforms with infinite resource space for each pixels on the internet maps (Complicated Dual Layer Infinite Platform (CDLIP)), that is to say that the information of the resource space of the dynamic Original Platform Background Component Elements (OPBCE) of the future internet platform is also infinite, and of course, the content information is also infinite;
(32). The Simple Single-Layer Infinite Platform (SSLIP) is a current traditional internet map or platform. According to famous mathematician Georg Cantor's infinity theory, the number of pixels in all graphs/maps is the Second Level Infinity, ie CDLIP is the second-level infinity platform. But the Complicated Dual Layer Infinite Platform (CDLIP) is the collection of all infinite map pixels in the internet map plus all of each pixels with all collection of combination of any subset of infinite resource spaces possessed by each pixel of the map, So CDLIP is a third-level infinity platform as per Georg Cantor's Infinity Theory. So number of elements in CDLIP is much much bigger than one in S SLIP. We emphasize here that the number of third-level infinity far far exceeds the number of the second-level infinity, that is to say, the Information resources that the Complicated Dual Layer Infinite Platform (CDLIP) has are far exceeding the ones that Simple Single-Layer Infinite Platform (SSLIP) does.
(33). The next-generation universal internet maps/platforms have more information content than the traditional internet maps/platforms. In terms of the total amount of these two platforms, The comparison of these 2 platforms' infinity is actually the third-level infinity to the second-level infinity;
(34). The major genetic flaws existed in the traditional internet maps of current Simple Single-Layer Infinite Platforms (SSLIP) have greatly limited and hindered the further development of the LAN in the downstream of the Internet such as the Internet of Things (IoT).
(35). The next generation of icons/markers of internet map developed and extended by the N-dimensional resource space in the present invention have created a lot of extremely rich and reusable upstream internet primitive ecological environment (IPEE) resources such as a series of new concepts of icon/markers defined by present invention, resources containers, resources folders, interface tabs, Icon/Marker Events, Icon/Marker Prediction etc., especially the Complicated Dual Layer Infinite Platform (CDLIP) concept, upstream internet primitive ecological environment (IPEE) resources and downstream internet primitive ecological environment (IPEE) resources, all these new rich reusable upstream internet original ecological resources greatly further stimulate and promote the dramatic development and ability of integration of the LAN in the downstream of the Internet such as the Internet of Things (IoT).
(36). The approach in present invention is that the problems in the downstream internet/networks can be solved by using upstream (totally newly extended and enriched internet/network primitive ecology environment (IPEE)) resources (new concepts such as overlapping icons and group icons etc).
(37). The original methodology and philosophy of the foundation theory and method of Internet Map Iconology/Markerology is to
(A). use the resources and solutions in high-dimensional space to solve the problems in low-dimensional space,
(B). solve the problems in downstream internet with upstream resources and solutions,
(C). solve the problems in the leaf node with the resources and solutions in main trunk, and
(D). solve the local problems with the global resources and solutions.
   (38). The foundation theory and method of Internet Map Iconology/Markerology is extremely important to solve the bottleneck problems the overall current internet platforms faced and to break down the current predicament in current traditional internet map/platforms for IoT.
   (39). The foundation theory and method of Internet Map Iconology/Markerology also creates the nested with the same type of resource containers or the self-nested structures with heterogeneous resource containers, and the nested and self-nested structures with elements like the entity tables etc, ie., the interface tab nested with interface tab, resource folder/container nested with resource folder/container and the entity tables nested with entity tables and further more, the complicated structures of all of these resource containers nested with each others;
   (40). The foundation theory and method of Internet Map Iconology/Markerology also permits the general common icons, overlapping icons and group icons etc in the internet maps to be nested, embedded and used in all kinds of resource containers such as the Interface Tab, resource folders and even Entity tables. The original concepts of the 3-Dimension and N-Dimension space are also suitable for all types of internet maps and their icons/markers with extended resource space.

### Part 2: Types of Icons/Markers

(1). General common icons/markers are the simplest icons/markers used by all current traditional internet maps;
(2). Overlapping icons/markers include two types of different icons: plane/horizontal overlapping icons/markers and 3-Dimensional/vertical overlapping icons/markers;
(3). Plane/horizontal overlapping icons/markers are icons/markers whose latitudes and longitudes are exactly the same and their altitudes are the same also.
(4). The 3-Dimensional/vertical overlapping icons are icons whose latitudes and longitudes are exactly the same but their altitudes are completely different.
(5). Both plane/horizontal overlapping icons/markers and the 3-Dimensional/vertical overlapping icons include the plane (3-Dimensional/vertical) same coordinates same address group icons/markers and the plane (3-Dimensional/vertical) same coordinates different address group icons/markers;
(6). The virtual icons/markers are icons/markers that do not exist on the internet maps at all. They are totally artificially created with assigned actual values of latitude, longitude and altitude according to users' requests by system administrator. They are also artificial icons/markers, there are no actual corresponding (direct) business entities associated with those icons/markers assigned with actual values of latitude, longitude and altitude in the real world;
(7). The virtual icons/markers include a plane/horizontal (vertical) Full Virtual Icons/Markers (FVI) & a plane/horizontal (Vertical) mirroring virtual icon/marker (MVI);

Full Virtual Icons/Markers (MVI) are icons/markers that represent totally non-existing business entities in the real world, they are phantom icons/markers.

mirroring Virtual Icons/Markers (MVI) are icons/markers that represent really business entities existed in the real world, but these entities did not have geographical address at this locations pointed by icons/markers now, they have actual address somewhere else. So mirroring Virtual Icons/Markers (MVI) act like the agents/puppets to perform all operations stipulated by the actual business entities in the background.

(8). Symmetric icons/markers: they are the icons/markers and their absolute values of latitude, longitude and altitudes are exactly the same as the original business entities, but the actual values of latitude, longitude and altitudes of each symmetric ones are opposite;
(9). Symmetric icons include axis (x-axis of horizontal, y-axis of horizontal, and z-axis of space vertical) symmetric icons and point symmetric icons;
(10). Symmetric icons/markers are one type of virtual icons/markers, which are convenient for rapid and large-scale deployment for some certain purposes (such as military, defense and social security etc). For example, missiles fired by enemy can fly back to their own positions and bombard their own targets under the guidance of virtual icons or Symmetric icons. Virtual icons and Symmetric icons can be used to cause the confusion and chaos toward the enemy and to let the enemy/opponent completely lose their direction, delay enemy's attack or lead the enemy/opponent to fall into the trap or ambush.
(11). The group icons/markers in internet map/platforms are collections of all certain types of icons/markers within a specified range;
(12). Furthermore, A group icon/marker is a collection of all icons with a certain kind of types or of a certain type in a specified certain area (2 dimensions) or of a certain type in a specified certain space (3 dimensions). A group icon/marker is a type of icon/marker to represent a certain number of icons/markers; in some cases, a group of icons/markers may be used as a functional-block or BlackBox to simplify input/output processing.

### Part 3: The Relationship Between Icons/Markers

(1). All internet map icons/markers can be associated/linked/connected with each other through some communication channels/modes;
(2). All internet map icons/markers can communicate with each other;
(3). The common communication modes between icons/markers can be point-to-point, point-to-area (Publish/Subscribe), Area-to-point and request-response etc;
(4). According to famous Germany Mathematician Georg Cantor's infinity theory, the pixels of the internet background map is infinity and it is also the second level infinity; but in the real world, there is a valid/effective icon/marker to represent a practical user or business entity associated with each pixels on the internet background map. These pixels associated with actual valid/effective user/business entities are called valid/effective pixels. But the number of valid/effective practical users or business entities is finite; and the set/collection of valid/effective pixels on the internet map is finite also, but the maximum ceiling limit number of valid/effective pixels' is second level infinity;
(5). The set of valid/effective icons/markers corresponding to the valid/effective pixels associated with actual business entities (actual users or real business objects) in the real world on the internet background maps is also finite, not infinite; these meaningful finite sets of all valid/effective icons/markers on the internet maps are finite sets of controllable icons/markers;
(6). All the icons/markers of internet maps are closely associated/linked with the real entities/users and their business activities or manufacturing industry activities except full virtual icons;
(7). All internet map icons/markers (icons can represent users, individuals, businesses or groups or physical objects) are the protagonists who will participate in all internet economy or manufacturing industry activities and play an irreplaceable role in online business and/or manufacturing industry activities;
(8). With the aid of icon/marker tab interface and resource containers' concepts, icons/markers can be nested with each others to form a complicated spatial structure;
(9). When the entity represented by the icon/marker is an object, the communication between icons/markers to represent the communication among objects-to-objects can be used in large-scale automatic control management in the manufacturing industry through artificial intelligence; The relationship between all icons/markers can be divided into three types of relationships:
A. a plane icon/marker relationship and
B. a vertical 3-Dimensional icons/markers relationship, and
C. a nested icons/markers relationship.

The relationship between 3-Dimensional icons/markers is more complex than that of plane ones.

### Part 4: Operation of Icons

(1). The users can operate on icons/markers. The main operations for icons/markers are Add, Delete, Modify, Search, Replace and Symmetric Clone (or Symmetric Copy) icons etc.
(2). Users can manage and control their own icons/markers and some other icons/markers through their icons/markers;
(3). Users can manage and control their own icons/markers and other icons/markers through some methods;
(4). The users can manage and control all the elements of the resource space in their own icon/markers through their icons/markers and some methods;
(5). Icons/markers can be weighted or add some value of weight;
(6). Different weighted icons/markers represent different priorities;
(7). Different weight icons/markers can be processed differently according to their priorities;
(8). Weighted icons/markers can speed up the process of search operation etc.

### Part 5: The Function of the Icons/Markers

(1). All online business, social, economic, transportation and manufacturing activities etc can be conducted through icons/markers associated with users, business entities, machines, things and merchants;
(2). All activities of business, social, economic, transportation and manufacturing of all internet map icons/markers constitute icon economy and icon business;
(3). Icon/markers economy includes icons/markers commercial (retail and wholesale) economy and icon/markers industry (manufacturing) economy;
(4). All internet map icons/markers are entrances and channels to integrate users and business entities with all external network platforms of their or other business;
(5). Since the pixels on the internet maps are second level infinity and they have unique and precise values of location and address, the foundation theory and method of Internet Map Iconology/Markerology will focus on valid/effective icons/markers only; therefore all meaningful finite sets of internet map icons/markers (ie, valid/effective icons/markers) can be normalized and standardized and can be uniquely identified, just like our personal ID. This normalization of icons/markers is the process to assign a unique icon identification number (IID) to each person or each object/thing concerned or each business entity in the real world. The identification number of icons/markers (IID) is an important core attribute and property for all authorization, authentication, recognition, searching, tracking, communication and management of icons/markers on the internet maps.
(6). The collection of icon/markers' network resource spaces is a set of spaces that the user can control, manipulate, connect and load all internal or external network resources. The icons/markers can link to the infinite space resources of users or business;
(7). The new 3-Dimensional/multi-dimensional internet maps/platforms iconology is the theoretical foundation for the next generation of new network maps/platforms;
(8). The next-generation brand-new internet maps/platforms based on the foundation theory and method of Internet Map Iconology/Markerology will completely change the current traditional maps as simple navigation platform into a multi-functional comprehensive platform to integrate all social, military, industry's internet resources; the foundation theory and method of Internet Map Iconology/Markerology will completely change the form of current/traditional internet maps/platforms by a new 3-Dimensional or even multi-dimensional internet map/platform;

### Part 6: Applicable Category of Foundation Theory of Iconology/Markerology

(1). The concept of foundation theory of Iconology/r Markerology is applicable to communicate all users, business entities and any objects in all levels in all platforms.
(2). Location application (positioning application) is the foundation application in the future, and the foundation theory and method of Internet Map Iconology/Markerology is to broaden the field of positioning application to Second level Infinity.
(3). All of the core concepts of icons/markers in this Iconology/Markerology will apply to the entire scope of the current traditional internet maps/platforms; in addition, it also includes the following extensions:
(4). The foundation theory and method of Internet Map Iconology/Markerology considers that all the dialogues and exchanges between all existing internet platforms are merely the senders of information and the recipients of information. Both the sender of information and the recipient of information can abstract into two categories: persons and things;

The relationships between the protagonists of the two types of dialogue and communication between Persons and things are as follows:
(A). Persons are the protagonists of dialogue and communication: such as social software Wechat, Snapchat. QQ, Facebook, etc.;
(B). Persons and things are the protagonists of dialogues and exchanges: for example, all e-commerce platforms and internet of things, etc.;
(C). Things and Persons are the protagonists of dialogues and exchanges: for example, all e-commerce platforms and internet of things, etc.;
(D). Things are the main characters/protagonists in the dialogue: Internet of Things and next generation of internet map;
(E). The Persons and things here can be one or more, so the combination of people and things is very complicated; see picture 1.

Scenario 1: The relationship between Persons and things (both static and dynamic)
(a) One person and many things;
(b) One person and one thing;
(c) Many-person and many things;
(d). Many people and one thing;

Scenario 2: Relationship between Persons (both static and dynamic)
(a). One person and more Persons;
(b). One person and one person;
(c). Multiple persons and one person;
(d). Multi-persons and multi-persons;

Scenario 3: The relationship between things and things (both static and dynamic)
(a) One thing and many things;
(b) One thing and one thing;
(c) Multi-things and multi-thing;
(d) Multi-things and one thing;

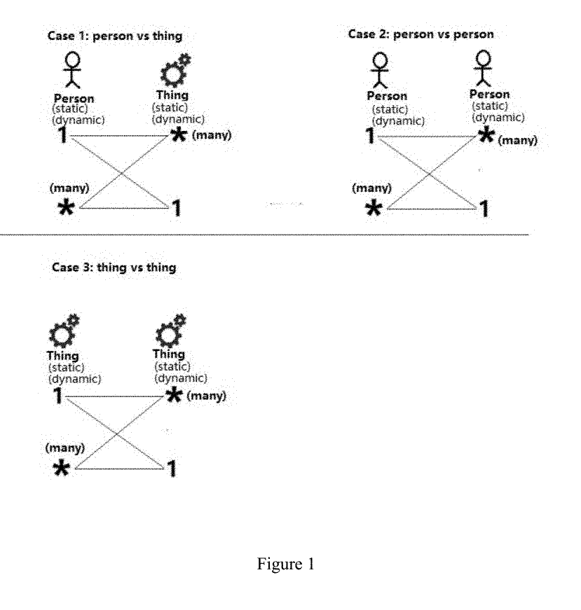

FIG. 1 includes the arrangement and combination of all relationships between persons and persons, persons and things, things and things (because control and messaging have different priorities).

All these intricate and complex relationships, especially persons and things, and the relationship between things and things reflect the basic relationship that the Internet of Things has to face and to solve in the real world.

(5). The world's first foundation theory and method of Internet Map Iconology/Markerology provides a brand-new solution for the realization of the Internet of Things (IoT). Using the iconology theory approaches in the present invention, the traditional way of centralized control of large-capacity gateway hosts in IoT can be changed to the actual discrete distributed and precise positioning model, which cuts down the cost of development and shortens the cycle of development for the users and brings up a totally new idea of energy-saving, efficient, environmentally friendly protected, economical and low-cost approach.
(6). Without using the foundation theory of the iconology in the present invention, all current traditional internet platforms, especially mobile internet platforms, have limitations for internet resource space and it is impossible to achieve complete dialogue and communication between all types of protagonists of Persons and Things; because according to the foundation theory of iconology, if the original background of internet platforms have lower the OBI information content, then they will have greater limitations and difficulty to extend to perform complicated internet activities without switching to external hi-dimensional platforms, these platforms are WhiteBoard platforms such as WeChat, QQ, Whatsapp and Snapchat, etc. As we said before, their content of the original dynamic background information OBI is zero, and it is almost impossible to perform complex internet activities if not to switch to the external internet platforms.
(7). The present invention completely covers the all dialogues and communications of all types of combinations of all persons and things with different status (static and dynamic), because the original background information (OBI) content of the next generation universal internet map of the present invention has the Second Level Infinity, the generic iconology of next-generation internet maps/platforms will provide a solid theoretical basis for large-scale and comprehensive participation of thing and persons in social communication, manufacturing, transportation etc., and especially in artificial intelligence management and the Internet of Things (IoT).
(8). The control of communication and circulation of things and things is actually the control of communication and circulation of end-to-end information and production materials from the beginning of raw materials to the end consumers, persons are only in the middle part. To ensure that the control of communication and circulation of production information and materials are unimpeded and smoothly going through, the best approach is to take the way of optimization, energy-saving and cost-saving, and the establishment of foundation iconology theory opens up new approaches and new solutions for the Internet of Things (IoT).
(9). The theory of Iconology and the new generation of internet Maps' participation in the communication, circulation, management and monitoring of the IoT also stimulate the huge basic need for the requirements of icons/markers' large-scale participation in artificial intelligence, big data and super computing.
(10). The foundation theory and method of Internet Map Iconology/Markerology in present invention and the new generation of internet maps/platforms can also allow direct communication among icons that belong to different LANs, different platform and different IoTs without quitting current sessions and then switching to the internet platform from time to time to avoid loss of valuable operational session data and to ensure that data from begin to the end user is passed through without even one stop.
(11). The foundation theory and method of Internet Map Iconology/Markerology of the present invention accurately and profoundly analyze the foundation relationship between highly abstract persons and things based on the current situations between persons and Internet platforms, and it participates in the entire human social and production ecological chain for large-scale network platforms: from raw materials=>transport industry=>Manufacturing Production=>Product Sales=>One-stop customer service etc, a complete industry enterprise chain provides a solid solution for all aspects in the daily life of human being.
(12). Because the original background information (OBI) content of the new generation internet map based on the foundation theory and method of Internet Map Iconology/Markerology of the present invention is infinite, and the icons/markers with infinite cardinality on the next generation internet map have infinite internet resource space (ie enriched icons/markers), so next generation internet maps/platforms with enriched icons/markers can participate in all complicated activities such as military activities, defense, anti-terrorism, manufacturing, real estate, aviation ans space, maritime transport, transportation, medical care and education, especially oil, gas, electricity (hydropower, nuclear power, wind power, photovoltaic, etc.), steel, automobile manufacturing, high-speed rail and other heavy industries and other light industries, and all IoT such as Internet of Vehicles, Maritime Internet of Things, Aviation Internet of Things, Railway Internet of Things, Medical Internet of Things, Real Estate Internet of Things, etc. in large scale.
(13). The foundation theory of iconology of the present invention created the concept of original overlapping icons/markers and area group icons/markers will show its unprecedented power in the Internet of Things (IoT).
(14). Classification of internet maps/platforms, classification of icons/markers and all their basic concept definitions, specifications, standards and rule development, such as internet map icons/markers, icon/markers resource containers (resource folders and interface tabs), the nesting among the same and different types of resource containers and icons/markers, the creation of their resource space and the management of all these resources and resources space do constitute the foundation core content of iconology.

The concept of 3-Dimensional overlapping icons has wide-spread application prospects in the fields of fire rescue of high-rise (such as the United States 9/11 events), exterior glass wall cleaning of high-rise, high-rise unmanned aircraft (drone) service delivery, aviation aircraft management etc, and it will have a tremendous effect and dramatic benefit for the society.

### Part 7: The Number of Valid/Effective Icons/Markers

The valid/effective icons/markers are those icons/markers that closely associate humans with some actual objects/things in human daily activities. The valid/effective icons/markers represent the entities/objects in a real world that play an active or passive role in participating in social, economic and production activities etc;

At present, there are about 7 billion human beings. and the maximum upper ceiling of current icons/markers of humans' population will not exceed 7 billion. However, the collection of subset of any population in the 7 billion should be more than 7 billion as per Georg Cantor's infinity theory. Therefore, we have the total number of valid/effective icons/markers related to all human beings not less than 7 billion, but its maximum ceiling number can be determined that it is not over First Level Infinity;

(3). According to Huawei's statistics, the total number of objects/things involved in the Internet of Things (IoT) is more than 50 billion of machine items/objects, so we set the total number of valid/effective icons/markers related to things/objects (machines) to not less than 50 billion, and the maximum upper ceiling number cannot be over First Level Infinity; Also about no less than 3 billion real estate (residential building, bridges, airports, road etc.) and a lot of animals etc can be also represented by icons/markers, so that no less than 60 billion valid/effective icons/markers will participate in all social, economic production and other activities of human beings. This does not include a large number of icons/markers that foundation iconology theory and icons/markers management system can fabricate and create at will such as virtual icons/markers (full virtual icons and mirroring virtual icons that have physical, geographic and economic value) and symmetric icons/markers. Therefore, the total number of valid/effective icons/markers participating in all social and economic production activities of humans is far far beyond the number of users of any current network platforms in the human beings history of internet. For example, Wechat is 1 billion, WHATSAPP more than 1 billion, Google Maps approximately 1 billion, Facebook 1.5 billion, Baidu's 1 billion and Apple's maps are about 60 million, which is a few orders of magnitude less than the minimum estimate of the number of users of all valid/effective icons created in iconology. The foundation theory of iconology and the core icons/markers management system technology will have the largest cardinality of users ever created and used by human beings.

### Part 8: Economic Value of Valid/Effective Icons/Markers in Social and Economic Production Activities

According to the conservative estimates of at least no less than 60 billion valid/effective icons/markers that we have roughly assessed above, which will participate in the all human social and economic production activities. The foundation theory of iconology points out that each icon involved in human social and economic production activities in theory will have at least a dollar of economic benefits.

All the number of icons/markers related to persons, the icons/markers related to the things/items, the group icons related to persons and things at same time, the group icons/markers related to things and things, and the icons/markers associated persons with persons at the same time, plus the collection consisting of group icon/markers is extremely large number of icons/markers that far exceed the minimum baseline of a valid/effective icons of 60 billion. Although this number is extremely large, it is still finite by Georg Cantor's theory of Infinity. Its maximum upper ceiling is First-Level Infinity. This number allows us to roughly estimate how much economic value the icon economy can produce at a minimum.

### Part 9: The Scale of the Icon Economy

Since the minimum number of existing valid/effective icons/markers associated with human beings activities is not less than 60 billion, which is tens or hundred or even thousands times of that of all users of all current online networks platforms, the scale of the icons/markers of the valid/effective icon/marker economy is the sum of the scale of social, economic production activities, that is, all business/commercial activities, all social activities, all manufacturing production activities plus together, So the total potential scale of the icons/markers economy of the valid/effective icons/markers is far beyond the economic scale of any current existing network platforms. That is almost equal to the full potential scale of the current economic scale of all network platforms plus that of the Internet of Things (IoT). According to Huawei's statistics, by 2020, the global demand for the Internet of Things (IoT) will increase dramatically, it will be reaching more than 7 billion people, more than 6 billion Internet users, more than 190 countries, more than 50 billion machines, and total global economic revenue will exceed US$ of 80 Trillion.

### Part 10: Valid Icons and QR Codes

The foundation theory and method of Internet Map Iconology/Markerology will introduce a two-dimensional QR code to bind to each valid unique Icon Identification number (IID). It is convenient for users to log in, add, connect and link to other icons to let them to communicate each other and to perform all operations on the icons, and to directly scan two-dimensional code and to eliminate the trouble of typing 20 to 50 icon numbers.

### Part 11: The Foundation Theory of Iconology and Three Super Platforms

According to the foundation theory and method of Internet Map Iconology/Markerology, all traditional network platforms can be divided into following three types of traditional basic network platforms:
(1) Type 1: Whiteboard platform;
(2) Type 2: Finite platform;
(3) Type 3: Infinite platforms.

According to the foundation theory of iconology, from the basis of an infinite platform, the traditional infinite platform is defined as One-Layer Infinite Platforms (OLIP), and furthermore an original new next generation platform/maps is defined as Two-Layer Infinite Platform (TLIP); based on these definitions, the present invention further defines following three types of traditional foundation networks platforms combined with the Dynamic Icon/Marker Management System (DIMS) invented by the foundation theory of iconology to form totally brand new types of super platforms:
(1). Whiteboard platform+Dynamic Icon/Marker Management System (DIMS)=next-generation Internet Super Social Platform (ISSP);
(2). Finite platform+Dynamic Icon/Marker Management System (DIMS)=next-generation Internet Super Finite Platform (ISFP);
(3). Infinite platform+Dynamic Icon/Marker Management System (DIMS)=next-generation Internet Super Integration Platform (ISIP).

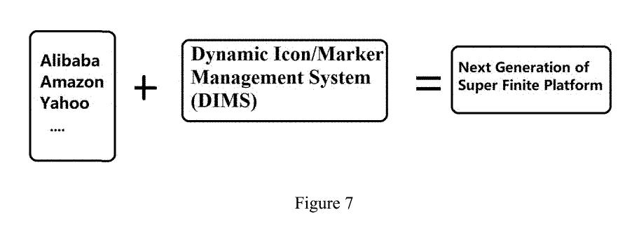

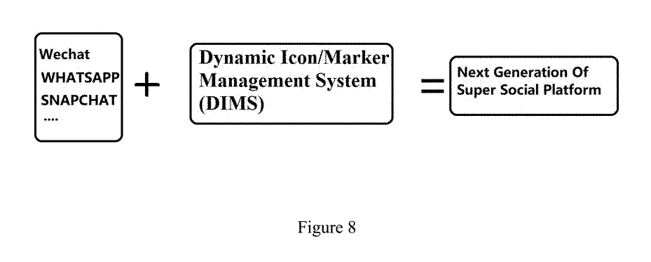

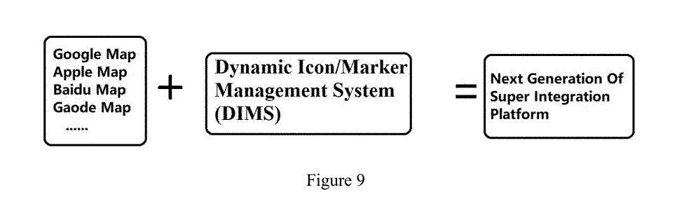

Among them, the Internet Super Integration Platform (ISIP) is biggest platform and is much much larger than the Internet Super Finite Platform (ISFP), and the ISFP is much much larger than the Internet Super Social Platform (ISSP); see FIG. 7, FIG. 8, and FIG. 9 respectively.

The Internet Super Integration Platform (ISIP) is the foundation of all other platforms, and is the largest network platform in the Internet era. The Cardinality of icon/marker Identification (IDD) in ISIP is Second Level Infinity.

From the setup of the foundation theory of iconology, the Dynamic Icon/Marker Management System (DIMS) has become a complete system with independent of any other network platforms. The Dynamic Icon/Marker Management System (DIMS) can be integrated with any network platform to form a new super platform.

### Part 12: Icon Identification Number (IID) and Traditional Network Platform User Identification (UID);

The foundation theory of iconology in Internet Map has introduced the most important and basic idea of icon identification number (IID) that is defined as the icon unique number, which means that the icon identification number (IID) of the next generation network super platform is a unique identifier for all icons/markers and its total number cannot be beyond Cantor's Second-Level Infinity (SLI), ie its maximum upper limit is the second level Infinity, far far more than the number of all integers in the first level infinity,

Compared with all the ID of traditional icons/markers, icon identification number (IID) or icon numbers are more abstract, more generic, more universal and more comprehensive, and any of person/people, animal or plants or things/objects on the earth can all have unique global icon identification number (IID) that are lifetime binding for them. This is hardest mission that Wechat ID in the social platform wechat, social security number (SSN), Animal ID, Road ID, Bridge ID, Building ID, Vehicle ID (VID), Satellite ID, document ID, machine ID and equipment ID of all different network platforms cannot identify and accomplish and they are not able to integrate together to identify all each others. Because so far, there is no super universal identification number that has this comprehensive ability to uniquely identify anything on the earth without using the present invention. The universality and generality of all things/objects with Second-Level Infinity on the earth and the real world require that identification number must have not only maximum capacity to contain and cover all different kinds/types of things/objects, but also the uniqueness of accurately positioned coordinates for their static or dynamic locations of these things/objects, we can see that all other IDs listed above are lack of this important attribute or short of other important attribute and finally they are failing to identify all other target persons or things outside of their own domains. For example, wechat ID cannot be used to identify devices, animal/insects, plants, vehicle and satellite etc, while device ID numbers cannot be used to identify people's social security number (SSN), medical insurance number, etc., But Icon Identification Number (IID) can be used to accurately identify all people and all target objects on the earth, this is the great task achieved by the present invention but there is no system and no platform ever achieved before.

Conclusion: IID can be used to identify anything on the earth.

In addition, the maximum number of wechat and SSN is the sum of all mankind, not more than 7 billion, and the equipment number is not less than 50 billion according to EU and Huawei statistics, which is within the limits of the first level infinity in Cantor's infinity theory. Ie., it is less than total number of integer; And the iconology theory not only unifies all the valid/effective thing/objects/targets with unique IID from all different unrelated fields/domains, but also can create any goal, any target on the earth that people think that it is valuable (such as certain points on the streets, telephone poles, wind turbines, space ships, comets, etc.) and give them each a unique icon number IID to manage and control these icons/markers concerned, So the number of IID in the present invention is much far beyond all known identification numbers managed by all traditional network platforms. The maximum upper ceiling of the number of IID is Second Level Infinity. It is infinite times First Level Infinity.

The above is a brief summary of the foundation theory of network map iconology/markerology and methodology of the present invention.

With this foundation theory and methodology of iconology/markerology as a basis, the present invention continues to formulate the following new concept definitions:

### Concept 1: Internet Map Icons/Markers Resource Space

is that all web pages, the interface tabs, and all resource containers associated with their icons/markers can be loaded with any amount and any content of network resources including web pages, interface tabs, all links of videos and other pages etc.; Here all icons/markers, the resource containers associated with these icons and their loaded network resources constitute these icons resource space; it is also infinite.

### Concept 2: Internet Map Icon Resource Container

All the icon resource containers of Internet map are the containers to contain and hold any type of internet platform primitive elements such as icons/markers, maps, web pages, resource folders, entity tables, interface tabs, drop-down boxes, buttons, dialogue boxes etc. There are mainly two types of icon resource containers: Icon Interface tabs and icon resource folders. These two types of containers can be nested with each other and can also load all other network resources and platforms. The icon interface tab of each icon is composed of a set of (at least one) interface tabs. The general common web page is a special case when the number of interface tabs is 1.

### Concept 3: Internet Map Icon Resources Folder (or Resource Folder)

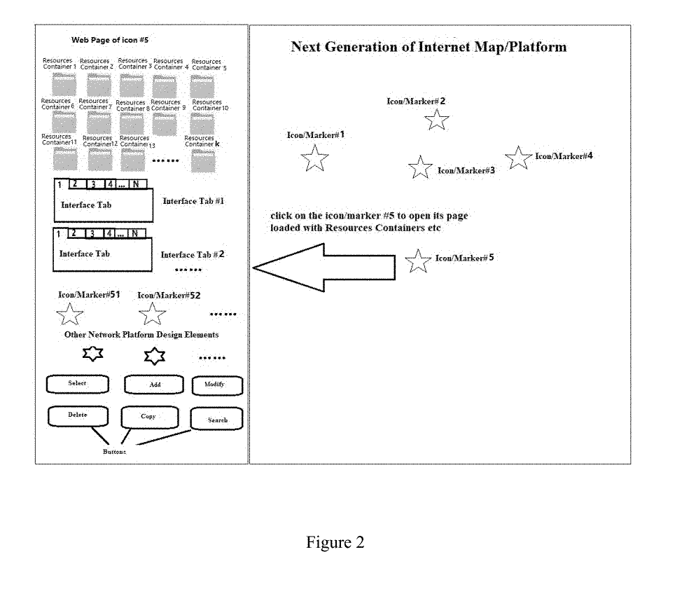

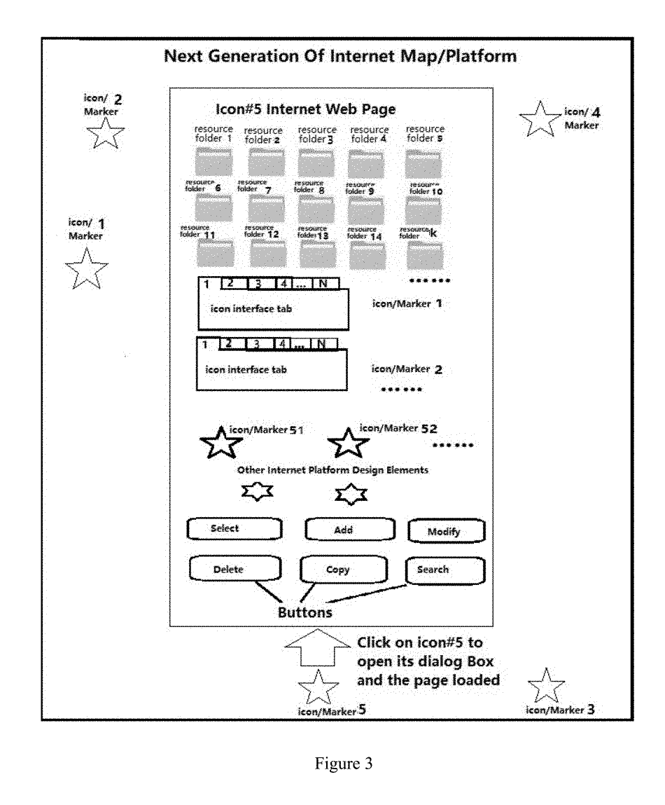

That is one of the icon's internet resource containers that can contain any number of external network resources including icons, icon interface tabs, icon resource folders, web pages and all links, videos etc. Each icon's resource folder consists of one or more sub-resource folders and/or other network resources and resources containers; see FIG. 2 and FIG. 3; icon interface tabs and icon resource folders are plural;

### Concept 4: Relationship Between Icon Resource Containers and Icons

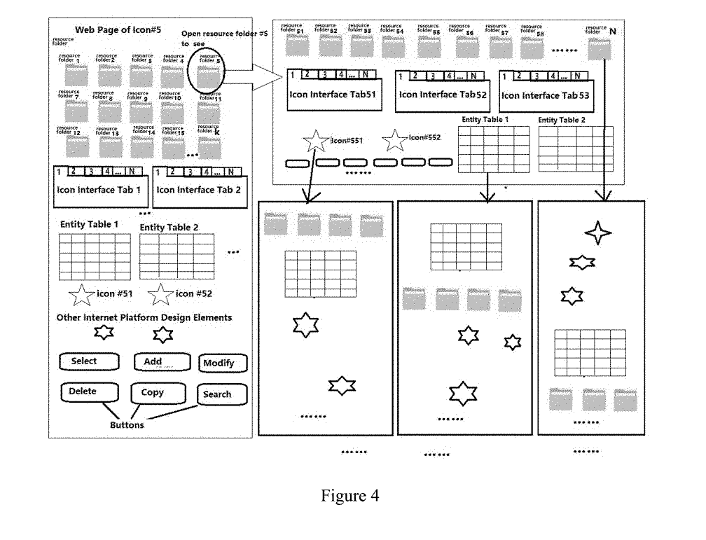

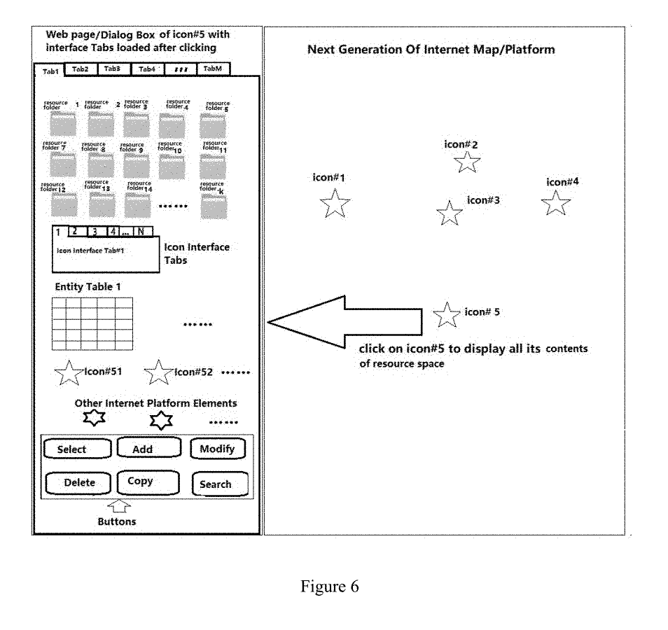

One of the icon resource containers is the icon Interface Tabs that is composed of many tabs, another one of the icon resource containers is the icon resource folder that is composed of many resource folders and/or icon Interface Tabs, and the relationship between the resource folders and the icons/markers can be nested, added and deleted; and the icon interface tabs can be nested to add, delete other icon resource folders and/or icons, and vice versa, the icon resource folders and icons can be nested to add or delete any icon interface tabs, icon can also contain resource folder and icon interface tabs, resource folder can also nest resource folder, icon interface tabs can also nest icon Interface tabs, and same kind of resource containers can be nested and different kind of resource containers can be nested each other and or self-nested (that is, interface tabs can be nested within interface tabs and resource folder can be nested within resource folders). See FIG. 4 and FIG. 6;

### Concept 5: Icon Identification Number (IID)

The icon identification number (IID) is an critical important basis for icon recognition, icon search, icon communication, icon management and other icon operations. This iconology theory assigns each valid/effective icon a unique 20 to 50-digit letter or number to identify the icons/markers assigned.

The present invention assigns a unique Icon Identification number (icon number or IID) to each valid/effective icon/marker and controls all the objects/things of the Internet of Things and Internet by controlling all these IID. Icon Identification numbers (IID) can be one-dimensional and two-dimensional. The icon Identification number (IID) of each valid icon has the following states:
(1) Activated, ie IID can be used;
(2) Inactive, ie IID cannot be used but need to send a request to re-activate;
(3) Register, ie IID did not exist, the user must register to request the server to assign an IID, then after register, it needs to be activated then it can be used;
(4) Delete, ie IID is removed from system.
etc.

These various states can be interchanged upon requests.

The foundation theory of network map iconology is to assign an IID to an effective/valid icon associated with each effective target/object (person or thing/object) on the earth (or even satellites in space orbit), the maximum upper limit of number of all effective/valid icons is the Second level infinity, and the dynamic icon/marker management system (DIMS) will efficiently control all valid/effective icons/markers through IID to achieve effective management and then to control all actual goals and targets represented by these icons in all internet platforms.

As per great mathematician Georg Cantor's Infinity theory, we set following variables to represent different numbers of users in different type platforms:

b=all users in traditional internet platforms such as Amazon, Google, microsoft, Oracle, intel, Alibaba, Baidu, etc., it is a collection of all integers such as 1, 2, 3, . . . ∞, its cardinality is First-Level Infinity;
c=all icons/markers in traditional internet maps and in next-generation internet platforms invented by the invention, it is a collection of all pixels on the internet maps/platforms, its cardinality is Second-Level Infinity;
d=Collection of all external internet resources, resources spaces and collection of their subset and combinations of all collection of all icons/markers on both traditional maps/platforms and next-generation internet maps/platforms invented by the invention, its cardinality is Third-Level Infinity;
b, c, and d have following relationships:

c=2^{b}

d=2^{c}

So c is infinite times of that b; and d is infinite times of that c;

### Concept 6: Operations of the Internet Map Icon/Marker Resource Containers

The operations of the icon resource container includes
A. adding,
B. deleting,
C. modifying,
D. copying,
E. searching,
F. Cloning etc
   to control all the icons and the icon interface tabs and the icon resource folders etc in the icon resource containers or pages, that is to perform all operations of all other network resources within the icon resource containers and other resources spaces or elements including icon resource containers themselves (interface tabs and/or resource folders), icons and other external network resources.
   Concept 7: The way to display internet map icons/markers and overlapping icons/markers in resource containers

In accordance with our previously defined overlapping icons including the Same Coordinates Same Address Group icon/marker (SCSAGM) and the Same Coordinates Different Address Group icon/marker (SCDAGM), the technology developed by the Iconology theory has the following methods to display the overlapping icons/markers:

Method 1: The method of using the icon interface tabs included in normal web pages/dialog box is to use the icon interface tabs with a series of tabs numbered from 1 to many and for each tab to load the business entity table, resource folders or other web page to display all the overlapping icons associated with actual business entities or persons or things;

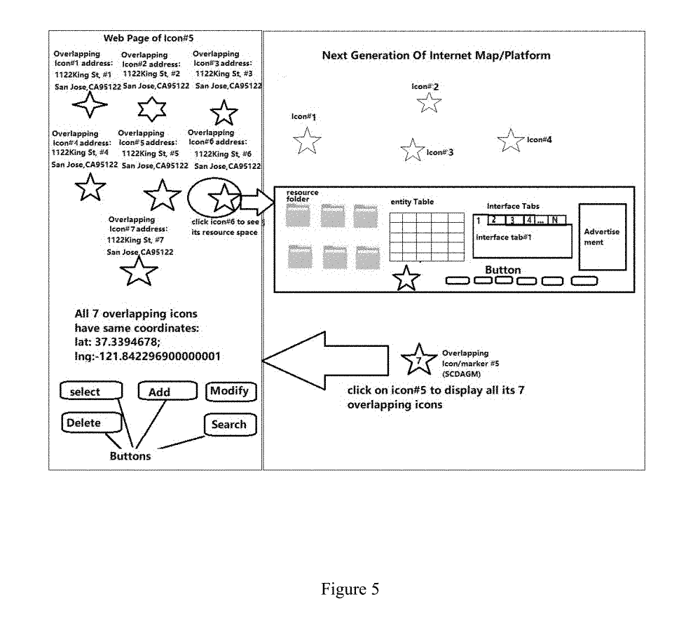

Method 2: Displaying all the overlapping icons associated with actual business entities or persons or things by the normal web pages/dialog boxes, resource folders and resources containers as shown in FIG. 5;

Regardless of the method of 1 or 2, we can do all followings:

(1). In the interface tabs, each tab can be loaded with the business entity tables, normal web pages, icons or resources folders;
(2). In the normal web pages/dialog boxes, the web page/dialog boxes can be loaded with the business entity tables, normal web pages/dialog boxes, icons or resources folders;

### Concept 8: Regulatory Control of the Resource Spaces of Common Icons/Markers, Group Icons/Markers and Overlapping Icons/Markers in Internet Map/Platform.

In all internet Maps/Platforms, this present invention of iconology theory can control and manage all Resource Spaces of all kinds of icons/markers such as common icons/markers, group Icons/markers & overlapping Icons/Markers with a series of operations such as: add, modify, delete, modify, search, copy and clone;

### Part 13: Icon Event.

Concept 9: An icon event is all the activities that a person or thing associated with the icon participates in at a given time.

So far, the foundation theory of iconology has discussed the most foundation and important aspects of the Internet, persons and things, and now will discuss another important aspect of the theory—the activities of persons and the activities of things: Events.

Firstly, the event will be defined here.

The event is the activity of the person and the activity of the object/thing. It is the activity space formed by persons or things plus time dimension. The concept of the icon event pioneered by the icon-based theory of Iconology introduces the time dimension to each icon of the dynamic icon management system (DIMS) for the first time, so that the icon management system can track the entire trajectory or road of the icon concerned from the start-point to the end-point in the dynamic environment along the time dimension of this event. All possible activities and events occurred along the way will be recorded and analyzed. Then the central cloud Icon Event Processing Servers will be used to process all events triggered by variety of reasons and the icons within specified time period.

According to the present invention of iconology theory, the icon that adds a time dimension to form a multi-dimensional object of an event can be used to represent a person, an object, or a group of people, a group of machines, an animal, a bridge, a phone line post or anything on the earth.

The cardinality of the icons in Iconology is Second Level Infinity, so the cardinality of the events associated with icons plus time dimension in Iconology is at least Second Level Infinity.

The event is an activity, it has a time dimension, that is, it has a time period with both a starting time and an ending time.

The icon event is the icon plus the time dimension and then becomes the icon activity.

The icon event is the sum of the trajectory of all the specified icon in the specified period. The icon trajectory includes a geographic location trajectory and an information trajectory of interaction. All icon trajectories have their time-stamps.

The single icon is a special case of group icons/markers when member icon within the group icon is only one in the group icon. So the group icon event is almost same as single icon event but more difficult when the number of members in the group icon is greater than 2. The more members, the more complicated the event.

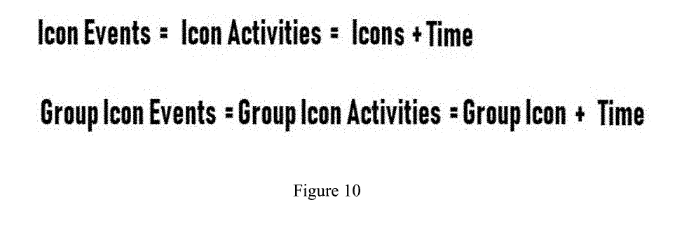

See FIG. 10 for both icon events and group icon events.

Events are further divided into the following different types of events:

(1). Natural Events: the activities that occur out of control of human beings, such as sunrise and sunset, Eclipses etc;
(2). Incidents: the events/activities that don't occur repeatedly under normal circumstances, such as Hen laying double yellow eggs, deformed babies, etc., ie these are small probability activities;
(3). Frequent events: the events or activities that occur repeatedly under normal circumstances, such as three meals a day, etc., these are high probability activities;
(4). Unexpected events: the events that are completely unforeseen, such as comets hitting the earth, volcanic eruptions, earthquake and tsunami, etc.;
(5). Accident: the events that may occur but are not expected to occur, such as car accidents, myocardial infarction, and cerebral congestion etc;
(6). Simple events: one activity or one event associated with one icon, which occurs over a period of time;
(7). Complex events: several activities and several events associated with several icons, that occur over a period of time;
(8). Controllable events: events that can be controlled through the consequences of persons' efforts or interactions: such as start or stop a running process by issuing a command or sending a message etc;
(9). Uncontrollable events: events that cannot be controlled by persons' efforts or actions, such as hurricane etc;
(10). Emergency Incidents: events that may occur but can be avoided if the planned route is changed as data analysis predicted because some other dangerous or problem or trouble or suspected icons may intersect with the icon concerned, such as shooting, killing, fighting, terrorism, kidnapping accidents, wild fire, flooding, etc;

The triggering conditions of different types of events are different, the results are completely different also, so the processing rules of network Icon Event Processing Servers are also different. How to effectively and correctly handle the results and mitigate the severe consequences caused by various events needs the introduction of artificial intelligence mechanisms to deal with all these complicated events associated with icons/markers.

The events such as emergency incidents are mainly caused by the intersection of target icon and the danger, suspected, trouble, questionable or unsafe icons (abbreviated as trouble icons) on the route planned by target icon, these trouble icons once overlapped/met with the target icons or intersected with the target icons on the planned route, it will cause some unexpected consequence or injury or accidents.

The commonality between the icon events and all traditional events is that they all have the time dimension, and the key difference between them is that the icon is a valid icon closely associated with all social activities of human beings and the icon events' maximum limit is the Second Level infinity, so all traditional normal existing events can be seen only as a subset of icon events. The trajectories of different types of icons at different times can be combined into extremely complex events, so icon events complexity will be much far beyond one of the current complex events in complex events processing (CEP).

The foundation of traditional complex event processing (CEP) is the RETE network algorithm, which has always dominated the world of enterprise complex event processing (CEP).

The total number of icon events in the icon event space consisting of all icon events is also the second level infinity. That is to say, the maximum upper ceiling of icon events is the second level infinity.

### Part 14: Icon Prediction

Concept 10: Icon Predication is to predict the possibility that the icon associated with the person or thing involved in the future planned time interval will participate in some certain activities by analyzing the data of the icon's all historical activities.

The concept of icon prediction pioneered by foundation theory of iconology introduces the logical reasoning of artificial intelligence (AI) into the dynamic icon management system (DIMS) combined with traditional rule system, so that the dynamic icon management system (DIMS) can track the history of activities of the icon in the past and also track all the history of activities of the other icons in the past that may have intersection on the route planned with the concerned icon and to predict all possible consequences that may occur or happen with concerned icon if they overlapped or intersected. So the Dynamic Icon Management System (DIMS) can collect all information for all icons along this route that may have intersection with the icon concerned and then provide necessary notification or alert or warning to advice or warn the concerned icon's owner to change, postpone or cancel the route to avoid potential injury or damage or danger in future.

At the same time, it can predict the negative events that may occur when various trouble icons will meet the target icons along the way they planned, the Dynamic Icon Management System (DIMS) will promptly warn, alert and notify them to prevent the worst situations, disasters or events from happening; and it can predict the positive events that may occur when various good, promotion or beneficial positive icons will meet the target icons along the way they planned, promptly remind the target icons' owners to make use of these beneficial opportunities. The icon will be then processed by the central cloud event servers and the best solution for target event with all events that will occur along the way will be provided to let the owners of icons to make correct choice.

The Icon events are the basis for icon prediction, and icon prediction is an extension of icon events.

Icon prediction is based on a large number of target icon's history data accumulated in the past to infer the possible consequences of the target icon and the probability of various events occurred and involved along the way planned by the target icon, so the application of big data application and artificial intelligence is necessary in the development of the Icon Event.

### Part 15: The Positioning Point

Concept 11: The Positioning Point pioneered by foundation theory of iconology/markerology in the present invention is that any pixel point with the value of latitude, longitude and altitude of GPS, Beidou systems on the network maps and network platforms can be used accurately to determine its geospatial position and then we can find its precise location. Then users can use the operations specified by the foundation theory of iconology to perform all operations on these pixels' icons/markers, that is, all geographic pixels of all network maps and network platforms can be precisely controlled. In this case, the positioning point becomes the controllable positioning point. The collection of all controllable positioning point is a subset of that of the positioning point.

### Part 16: The Controllable Positioning and the Positioning Controllable

Concept 12: The Controllable Positioning pioneered by foundation theory of iconology/markerology in the present invention is that any pixel point with the value of latitude, longitude and altitude of GPS, Beidou systems on the network maps and network platforms can accurately determine its geospatial position and then accurately we can find it precise location. Then users can use the operations specified by the foundation theory of iconology to perform all operations on these pixels' icons/markers, that is, all geographic pixels of all network maps and network platforms can be precisely controlled.
Concept 13: The Positioning Controllable pioneered by the present invention is that the all resource space of all valid icon of the pixels with the values of latitude, longitude and altitude of GPS or Beidou system (or Big Dipper System) on the network map and network platform can be fully manipulated and controlled. That is to say that the resource space of the valid/effective icons/markers can be operated by the foundation theory of the iconology, that is, the resource space of the effective icon of all the geographical pixels of all the network maps and the network platforms can be precisely controlled.

The concept of the controllable positioning and the concept of the position controllable are different. The positioning controllable is that the all resource space of each pixel (platform pixel or valid icon) on the internet maps/platforms is completely controllable, these resource space of each pixel is in another totally different dimension and the controllable positioning means that each pixel (platform pixel or valid icon) on the internet maps/platforms is controllable.

### Part 17: The Icon Information Bus (IIB)

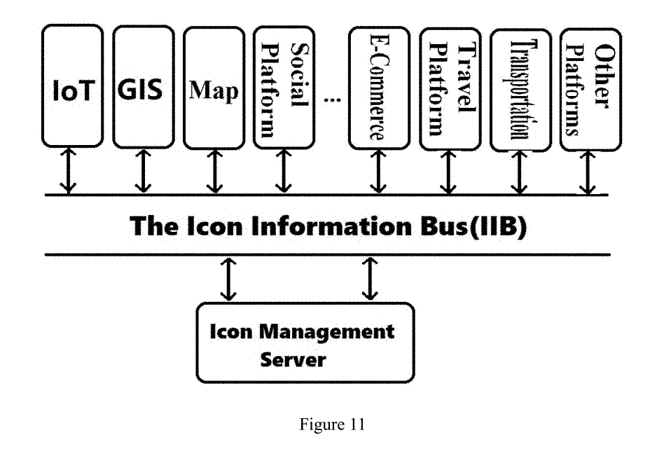

Concept 14: The Icon Information Bus (IIB) is the main information bus used by the network platform to communicate, exchange and transmit the icon identification number (IID) and all related information. It is the main aorta and main highway that integrates the icon information resources of all network platforms. See FIG. 11.

The positioning points and icons/markers are the most important basic elements of all network platforms such as network maps, GIS platforms and IoT platforms. The basic theory and method of network iconology is the discipline that reveals the basic laws of the most important basic elements of all Internet platforms. The invention originates from a network map platform and then extends to the entire internet network platform.

### Part 18: Controllable Positioning Identification Number (CPID) Vs Icon Identification (IID)

Concept 15: Controllable Positioning Identification Number (CPID is Controllable Positioning Identification) is that any controllable positioning point in the physical space can theoretically give a unique identification number to control the positioning point identification number (CPID).

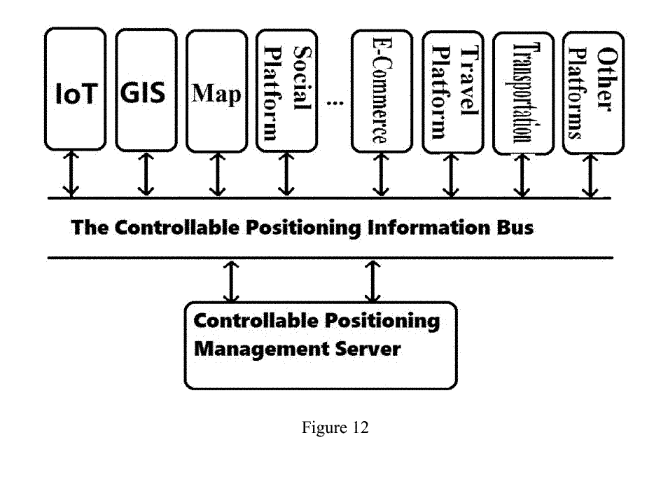

The controllable positioning point identification number is a more abstract concept that is more general than the icon number. All controllable positioning points in the realistic three-dimensional physical space can be calibrated. The Controlled Location Point Identification Number (CPID) can be used to calibrate any of the controllable anchor points in the subterranean space in space. The set of all network map icon numbers is only a subset of the Controlled Location Point Identification Number (CPID) set, although According to Cantor's theory, both sets are second-order infinity. See FIG. 12 for the controllable positioning information bus (CPIB) and the controllable positioning management server.

The foundation theory and method of the internet map iconology in the present invention include a complete theoretical icon system, a set of concept definitions and a series of rules stipulated. According to the foundation theory and method of the present invention and the rules designed, the users can perform various operations on the icons using iconology theory and methods listed and connect all existing external internet resource and network platforms through the icons to carry out various network business, commercial, social and icon economic activities. This is currently impossible with traditional internet map technology.

The concept of original icon resource space, the concept of icon resource container, the concept of icon resource folder, the concept of icon identification number (IID), the concept of icon's QR Codes, especially the concepts of nesting of same/different kinds of resource containers (nested or self-nested each other) in resource containers and/or in entity tables (ie interface tabs nested within interface tabs and resource folder nested within resource folders and/or entity tables nested entity tables etc), the concept of icons of network map and the overlapping icons displayed in the resource container, the concepts of the 3-Dimension and the N-Dimensional spaces are also suitable for all types of network maps above-mentioned and their extended resource space; all concepts of the present invention of Iconology theory are shown in FIG. 2, FIG. 3, FIG. 4, and FIG. 5, FIG. 6 for all types and their variants.

the foundation theory and method of Iconology in the present invention have the universality of being totally independent of any specific platforms, and are suitable for all Internet map applications of current computer and mobile phone applications all over the world, such as Google Map, Apple Map, MapQuest, Baidu Map, QQ maps, Gaode maps, Sogou maps, European HERE map etc.

The iconology of the present invention uniquely creates and defines several different kinds of icons/markers such as overlapping group icon/marker (the Same Coordinates Same Address Group icon/marker (SCSAGM)), and various virtual icons (full virtual icons/markers & mirroring virtual icons/markers), various symmetric icons (including X-axis symmetry, Y-axis, z-axis symmetry, and origin symmetry of 4 types of symmetric icons) and variety of group icons/markers. They are all suitable for all network maps/platforms and their extended internet resource space;

The original concepts of all kinds of icons/markers created by the present invention (including various types of overlapping icons, various types of virtual icons, various types of symmetric and virtual icons and various group icon concepts), the concepts of various types of interface tabs, the concepts of entity table, the concepts of icon resource space, the concepts of icons resource container, the concepts of icon resource folder, the concepts of icon identification number (IID), the concepts of all icon operation etc and the concepts of icon event and icon prediction are suitable for all network maps/platforms types and their associated resource space; all the concepts of the iconology/markerology theory and their deformations and extensions are covered in FIG. 2, FIG. 3, FIG. 4, FIG. 5 and FIG. 6; They can also be extended broadly to define in any static state, as well as dynamic state, or to any form of ellipses/oval, squares, rectangles, polygons and the planes or surfaces on which these shapes reside and are located and their deformation containers/carriers, including Argument Reality (AR) and Virtual Reality (VR) or holographic containers or platforms and their various deformations of containers or platforms.

### A Specific Embodiment

The following clearly and completely describes the technical solutions in the embodiment of the present invention. Apparently, the described embodiments are merely some but not all of the embodiment of the present invention. All other embodiment obtained by a person of ordinary skill in the art based on the embodiment of the present invention without creative efforts shall fall within the protection scope of the present invention.

Please refer to FIG. 2, 3, 4, 5, 6, an embodiment of the present invention includes: The specific steps of a network map iconology foundation theory and method include:

Step 1: According to the iconology theory, a 20 to 50+ digit icon identification number (IID) is assigned to each user/merchant/thing as a unique icon/marker identification number (IID) and is also lifetime binding;
Step 2: The web site URLs or other IoT URLs associated with each element in the icons/markers will be provided by all the icons' owners for all these icons/markers and will be loaded into web page or resources containers like interface tabs etc when they are clicked,
Step 3: The system will load all the resource containers such as the interface tabs assigned to each icon/marker by loading each monitoring interfaces associated with each interface tab according to the latitude, longitude and altitude value of each icon, and will group all icons/markers of Same Coordinates Same Address (SCSA) or Same Coordinates Different Address group marker (SCDAGA) marked by a number to represent total number of icons/markers it contained, and then user/merchant can perform operations defined in iconology theory on these icons within this SCDAGA, interface tabs and resource folders as above-mentioned. These operations can be add, delete, modify, copy, search, etc through buttons in the entity table.

Actually, after completion of these operations such as deletion, the icons/markers are only removed from the internet map and they are not displayed on the maps, but not actually removed from the back end database, ie these icons/markers are still in memory, if user uses add operation, all these removed or deleted icons/markers will be added back to internet maps again. The operations performed only show that users/merchants have ability to control and manipulate any icon/marker on the internet maps. Operation of modify will update the information and attributes of the icons/markers in the back end system such as database after confirmation.

Step 4: If the algorithm is not running normally, the application system will perform corresponding processing on the operation result to handle any exception/errors. If the algorithm is running normally, the system will display all the icons on the internet maps of the mobile terminal or PC after the operation performed.
Step 5: Once all the icons/markers on the internet maps of the mobile terminal were displayed on the internet maps, the user/merchant/manufacturer can click on the concerned icons/markers and then can enter into each of the concerned resources containers such as interface tabs to monitor and control all links connected with each items in each interface tab or ones in the corresponding group markers in real time.

### Specific Embodiment One

Taking FIG. 5 as an example, the user clicks on the overlapping icon/marker marked #3, which contains 7 elements/entities. This icon is still the icon/marker of the same coordinates different addresses Group Marker (SCDAGM) that includes the address of 1122 KING STREET, #1, SAN JOSE, Calif. 95122, but several other different company addresses. Like room number of #2, #3, #4, #5, #6, #7; As long as the user clicks on the group icon/marker of the same coordinates different addresses (SCDAGM), a simple web page/dialog box with the entity table (or other resource containers like the Interface Tab or Resources Folders etc) containing 7 icons/markers are displayed clearly. This entity table lists all 7 overlapping icons contained in this overlapping group icon/marker in 7 different rows in the table. Each row represents one icon/marker or actual user/merchant, in each row, there are several different cells that each is connected to different URL predefined to connect to different external internet resource or application. just click on any one cell' link in any row of the entity table user can immediately open a dialog box that contains a series of resource containers contained in the icon resource space, each resource container loads a different network resources and control buttons, here it is easy to control and manipulate all resources through the present invention of technology.

For example, the user only needs to open the resource container of the icon 6 loaded in the sixth interface tab, which includes several resource folders, entity tables, icons and interface labels, and manipulation buttons. Just click on each element in the resource container (resources Folders, entity tables, icons, and interface tabs etc) the users can go to the next level of resource containers or linked web platforms, or click buttons to manipulate the current element.

The above descriptions are merely examples of the present invention, and are not intended to limit the scope of the present invention. Any equivalent structure or equivalent process transformation made by using the contents, concepts, standards and drawings (FIG. 1 to FIG. 10) or architecture structures (FIG. 1 to FIG. 10) of the present specification is directly or indirectly applied in other related technical fields, the same applies to the protection scope of the present invention. Furthermore, the appended claims of the present invention are intended to cover all changes and modifications that fall within the scope and the borderline of the appended claims, or the equivalents of such scopes and boundaries.

All such equivalent embodiments and examples are within the spirit and scope of the present invention, are contemplated thereby, and are intended to be covered by the following claims.

### REFERENCES

[1]. Internet Map Macro Marker Management Theory and Control System, application Ser. No. 15/664,152; Filing Date: Jul. 31, 2017;
[2]. Internet Map Virtual Marker Dynamic Management Theory And Method, application Ser. No. 15/821,813; Filing Date: Nov. 23, 2017;

What is claimed is:

1. Initiate and implement a completely foundation theory and method of Internet Map/Platform Iconology/Markerology, characterized in followings:
The foundation theory & method of the internet map/platform Iconology/Markerology in the present invention includes a complete theoretical icon system, a set of concept definitions and a series of rules stipulated. According to the foundation theory and method of the present invention and the rules designed, the users can perform various operations on the icons by using iconology theory and methods listed and connect all existing external internet resource and network platforms through the icons to carry out various network business, commercial, social and icon economic activities. The theory and method of the present invention can be applied to all kinds of internet maps such as Google Map, Apple Map, MapQuest, BaiduMap, Gaode Map etc and can be also applied to all internet platforms such as all kinds of GIS platforms and all kinds of IoT Platforms and the similar ones. This is currently impossible with traditional internet map/platform technology.

2. For the claim 1, the foundation theory and method of the internet map/platform Iconology/Markerology, which includes:
the concepts of the controllable positioning, the positioning controllable, the positioning point, the controllable positioning point, the controllable positioning point, the controllable positioning point identification number (CPID), the Icon Information Bus (IIB), the Controllable Positioning Information Bus (CPIB), the controllable positioning management server, the icon management server, a series of concepts of the icons/markers such as different kinds of overlapping group icons/markers wherein the Same Coordinates Same Address Group icon/marker (SCSAGM) and the Same Coordinates Different Address Group icon/marker (SCDAGM), different kinds of virtual icons wherein full virtual icons/markers & mirror/mirroring virtual icons/markers, various symmetric icons wherein including X-axis, Y-axis, Z-axis symmetric icons, and origin point symmetric icons of 4 types of symmetric icons, all different kinds of group icons/markers wherein Area Group Icon/marker and Central Master Group Icon/marker etc, the concept of original icon resource space, the concept of icon resource containers, the concept of icon interface tabs, the concept of icon resource folder, the concept of the classifications of platforms such as the WhiteBoard platform, the Finite platform and the Infinite platform, the concept of the original background information (OBI), the concept of the original background information (OBI) content, the concept of Simple Single Layer Infinite Platform (SSLIP), the concept of Original platform background component elements (OPBCE), the concept of Complex Dual Layer Infinite Platform (CDLIP), the concept of internet primitive ecological environment (IPEE), The concept of icon business, The concept of icon economy, The concept of valid/effective icons/markers, the concept of icon identification number (IID), the concept of icon's QR Codes, especially, the concepts of nesting of same/different kinds of resource containers (nested or self-nested each other) in resource containers and/or in entity tables (ie interface tabs nested within interface tabs and resource folder nested within resource folders and/or entity tables nested entity tables etc), the concept of icons of network map and the overlapping icons displayed mode in the resource container, the concepts of the 3-Dimension and the N-Dimensional spaces, the concepts of all icon/marker operations, the concepts of icon events, the icon predictions that are all definitions defined in the present invention and are suitable for all types of network maps above-mentioned and their extended resource space; almost all concepts of the present invention of Iconology theory are shown in FIG. 2, FIG. 3, FIG. 4, and FIG. 5, FIG. 6 for all types and their variants. They can also be extended broadly to define in any static state, as well as dynamic state, or to any form of ellipses/oval, squares, rectangles, polygons and the planes or surfaces on which these shapes reside and are located and their deformation containers/carriers, including Argument Reality (AR) and Virtual Reality (VR) or holographic containers or platforms and their various deformations of containers or platforms;
the foundation theory and method of Iconology in the present invention have the universality of being totally independent of any specific platforms, and are suitable for all Internet map applications of current computer and mobile phone applications all over the world, such as Google Map, Apple Map, MapQuest, Baidu Map, QQ maps, Gaode maps, Sogou maps, European HERE map etc.

3. For the claim 1, the foundation theory and method of the internet map/platform Iconology/Markerology, which includes: that the internet map also is an abbreviation of internet map/platform, because the icons/markers we use here can be not only used in the internet maps such as Google Map, Baidu map etc but also used in all other platforms and their applications such as all types of GIS and all types of IoTs, so the term of platform or “Platform” means all different types of GIS platforms or all these different types of LoT platforms or any platforms that will use the concepts of icons/markers or the similar defined here. And the term of “mirror” is same as “mirroring” in our present invention.

4. For the claim 1, the foundation theory and method of the internet map/platform Iconology/Markerology, which includes:
Any equivalent structure or equivalent process transformation made by using the contents, concepts, standards and drawings (from FIG. 1 to FIG. 12) or architecture structures (from FIG. 1 to FIG. 12) of the present invention is directly or indirectly applied in other related technical fields, the same applies to the protection scope of the present invention. Furthermore, the appended claims of the present invention are intended to cover all changes and modifications that fall within the scope and the borderline of the appended claims, or the equivalents of such scopes and boundaries.
